(19) United States
(12) Patent Application Publication
(10) Pub. No.: US 2009/0207903 A1
(43) Pub. Date: Aug. 20, 2009

(54) Method of Making Media Files Available for Delivery to Portable Electronic Devices

(76) Inventor: Philip John, Vale of Glamorgan (GB)

Correspondence Address: NIXON & VANDERHYE, PC, 901 NORTH GLEBE ROAD, 11TH FLOOR, ARLINGTON, VA, 22203, US

(21) Appl. No.: 12/084,550

(22) PCT Filed: Dec. 6, 2006
(86) PCT No.: PCT/GB2006/004560

§ 371 Date: Apr. 17, 2009

(30) Foreign Application Priority Data
Dec. 8, 2005 (GB) 0525005.5
Feb. 20, 2006 (GB) 0603298.1

(51) Int. Cl. H04N 11/04; G06F 21/00; G06F 17/30; H04M 3/42

(52) U.S. Cl. 375/240.01; 713/153; 707/10; 455/414.1; 707/E17.01; 375/E07.026

(57) ABSTRACT

There is described a method of making media files, for example video clips available for delivery to portable electronic devices, for example mobile phones. The method comprises receiving media content as data input at an encoder and encoding the media content to generate a plurality of output files each having the media content. Each of the plurality of output files is specially adapted by the encoder for use with a different model of mobile phone. The plurality of output files are stored on a server for downloading there from over a communications network. A user can download to a computer an output file compatible with his or her mobile phone and transfer the file for the computer to the mobile phone.

The present invention relates to a system of making media files, in particular but not exclusively video files, available for delivery to portable electronic devices, in particular but not exclusively mobile phones.

Modern mobile phones have extensive media playback facilities, whether it be video, audio, images or ring tones. The principle route by which such media information is delivered to these phones is via the mobile phone network. Network operators control the flow of information to the end user and in most cases allow the networks to be used by third parties, to deliver media content, for example ring tones and images. However, the recent launch of third generation mobile phones coupled with the heavy investment in developing and licensing third generation networks has resulted in a reduction of the number of third parties which can access the network to deliver video and other media content to mobile phones.

Where third generation networks are not available, video transmission is limited by the speed of second generation mobile networks, which were never designed to carry the bandwidth that is necessary for video. Thus, low speed networks, coupled with restricted access to third generation networks, has created a bottleneck in the distribution of video content. However, neither of these limitations are imposed by the mobile phone itself. Most mobile phones are now available with excellent playback capabilities and so the user is only limited in the way in which the video or image can get into their phone.

Embodiments of the present invention aim to provide a convenient system for delivering media content to a wide variety of different portable electronic devices, for example, different mobile phones.

In accordance with this invention as seen from a first aspect there is provided A method of making media files available for delivery to portable electronic devices, the method comprising: receiving media content as data input at an encoder; encoding the media content at the encoder to generate a plurality of output files each having the media content, each of the plurality of output files being specially adapted by the encoder for use with a different portable electronic device; and storing the plurality of output files on a server for transmission there from over a communications link.

In accordance with a second aspect of the invention there is provided a method of delivering a media file to a portable electronic device, the method comprising: downloading from a server to an electronic store over a communications network link a media file made available for delivery to portable electronic devices in accordance with the first aspect; transferring the media file from the electronic store to a portable electronic device.

In accordance with a third aspect of the invention there is provided apparatus for making media files available for delivery to portable electronic devices, the apparatus comprising: an encoder for receiving media content as data input and encoding the media content to generate a plurality of output files each having the media content, and wherein each of the plurality of output files is formatted differently by the encoder so that the media content is available for use with a variety of different models of portable electronic devices; and a server for storing the plurality of output files for downloading there from over a communications link.

The preferred embodiments of this invention will now be described by way of example only and with reference to the accompanying drawings which illustrate the sequence of events in delivering a video clip to a mobile phone.

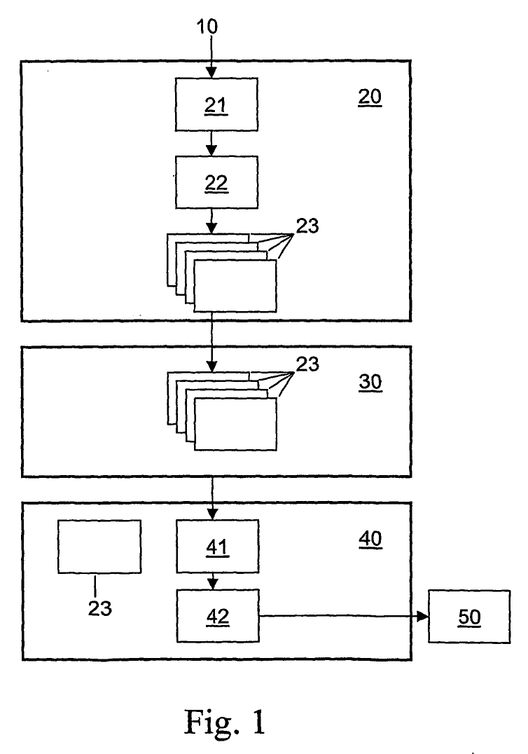

Referring to FIG. 1, a system embodying the present invention comprises a video file processor 20, a server 30, a computer 40, for example a PC, connectable over a data network (not shown) to the server 30 and a portable electronic device 50 for example, a cellular phone. The video file processor 20 receives as input a video file, for example a music video clip of a pop band and converts the input video file into multiple output files 23. Each of the multiple output files 23 has at least one different parameter from the others, so that each of the multiple output files 23 is specially adapted for playing on at least one different type or model of cellular phone than are the others.

The multiple output files 23 are output from the video file processor 20 and stored on a computer server 30. A user of the computer 40 is able to connect to the server 30 over a public data network, for example the Internet, in order to download to the computer 40 which ever one of the files 23 is specially adapted for playing on the user's particular mobile phone 50. Once downloaded to the computer 40, the downloaded file may be transferred from the computer 40 to the mobile phone 50 by any suitable means for example, a Bluetooth connection.

The system will now be described in more detail.

The video file processor 20 is input with a selected media file for example an MPEG video clip, from a video clip source 10. The input file is then encoded via an encoding stage 21, into the plurality of mobile phone video files 23, each file being optimized for a different type of mobile phone.

The diverse range of mobile phone models on the market means that there is a variation in what is required of a video file in order for it to playback properly on a given mobile phone. The function of the video file processor 20 is to create multiple output files 23 with varying parameters so that there is likely at least one suitable file for a particular user's mobile phone 50

In one embodiment the following parameters are taken into consideration when generating the output files 23.

Video Compression Codec

There are commonly used video compression codecs on mobile phones and other mobile devices. These codecs conform to the following international standards; H.263, H.264, MPEG-4. Other suitable video compression codecs are known to those skilled in the art.

Audio Compression Codec

There are presently three commonly used audio compression codecs on mobile phones and other mobile devices. These codecs the plurality of mobile phone video files 23, each file being optimized for a different type of mobile phone.

The diverse range of mobile phone models on the market means that there is a variation in what is required of a video file in order for it to playback properly on a given mobile phone. The function of the video file processor 20 is to create multiple output files 23 with varying parameters so that there is likely at least one suitable file for a particular user's mobile phone 50

In one embodiment the following parameters are taken into consideration when generating the output files 23.

Video Compression Codec

There are commonly used video compression codecs on mobile phones and other mobile devices. These codecs conform to the following international standards; H.263, H.264, MPEG-4. Other suitable video compression codecs are known to those skilled in the art.

Audio Compression Codec

There are presently three commonly used audio compression codecs on mobile phones and other mobile devices. These codecs conform to the following known international standards; AMR Narrowband (NB) AMR Wideband (WB) and AAC. Other suitable audio compression codecs are known to those skilled in the art.

Video Bandwidth

When a video file is encoded a speed is chosen for the video encoding, analogous to transmitting the video over a live network. A typical speed might be 100 kb/s, but mobile devices vary greatly in what speeds they can support. The encoder offers the flexibility to encode the video at a variety of speeds to match the capability of the playback devices.

Audio Bandwidth

Although there is less; variation among mobile devices in terms of audio encoding speed the encoder offers the flexibility to encode at more than one speed, or offer mono or stereo to increase audio quality.

File Format

There are three commonly used general file formats for mobile video, 0.3gp, .mp4 and 0.3g2. The encoder offers the output in these and other formats.

The large number of possible combinations of these parameters means that in theory, the video file processor 20 could be arranged to generate hundreds of output files of different combinations of parameters from a single input video file. In practice this would not be practical and so output files are generated in accordance with a limited number of parameter combinations or profiles selected to cover the most common combinations of parameters appropriate for the majority of mobile phone models on the market.

Table 1 shows a typical list of parameter profiles stored in a database in the system (not shown) and applied by the encoding stage 21 to the single input MPEG file.

TABLE 1

| | Video | Audio | | | |
|---|---|---|---|---|---|
| Profile # | Codec | Codec | Video BW | Audio BW | Format |
| 1 | H.263 | AMR NB | 100 kb/s | 12 kb/s mono | .3gp |
| 2 | H.263 | AMR NB | 200 kb/s | 12 kb/s mono | .3gp |
| 3 | H.263 | AMR NB | 300 kb/s | 12 kb/s mono | .3gp |
| 4 | MPEG-4 | AMR NB | 100 kb/s | 12 kb/s mono | .mp4 |
| 5 | MPEG-4 | AMR NB | 200 kb/s | 12 kb/s mono | .mp4 |
| 6 | MPEG-4 | AMR NB | 300 kb/s | 12 kb/s mono | .mp4 |
| 7 | H.263 | AAC | 100 kb/s | 24 kb/s mono | .3gp |
| 8 | H.263 | AAC | 200 kb/s | 24 kb/s mono | .3gp |
| 9 | H.263 | AAC | 300 kb/s | 24 kb/s mono | .3gp |
| 10 | MPEG-4 | AAC | 100 kb/s | 24 kb/s mono | .mp4 |
| 11 | MPEG-4 | AAC | 200 kb/s | 24 kb/s mono | .mp4 |
| 12 | MPEG-4 | AAC | 300 kb/s | 24 kb/s mono | .mp4 |

The exact number of profiles used by the video file processor 20 can be chosen by the operator. For example, a particular video provider may want to access a particular group of mobile users with certain common characteristics.

The encoding stage 21 receives the input file and encodes it multiple times to create the multiple output files. Each encoding is performed in accordance with a different profile and the parameters of that profile. Thus for example, an output file encoded in accordance with profile 8 has video Codec H.263, Audio Codec AAC, Video BW 200 kb/s, Audio BW 24 kb/s mono and format 0.3gp.

Preferably, the plurality of output files are generated in parallel, substantially at the same time.

In one embodiment, each output file is assigned a unique identifier which also indicates the associated profile used to encode the file, e.g. sample video p08.3gp, in this case identifying that profile #8 was used to encode the file.

To prevent a user simply downloading a file and viewing it on their computer 40, the plurality of files 23 are additionally encoded into a proprietary file format in an additional encoding stage 22. The output files are then loaded onto a server 30, typically a web-server.

When an authorised user uses their computer 40 to browse to the server 30, they identify which type of mobile device 50 they have. The server 30 uses a database to equate the device 50 with one or more potentially compatible output files 23. For example a user with a Nokia 6620 mobile phone might be offered the three output files generated with profiles 1, 2 and 3, to give a choice of three video bandwidth speeds. The user can then decide which speed (and thus picture quality) and file size to download to their computer.

Once the end user has downloaded the file 23 onto their computer 40, it is available for transfer to their mobile phone 50 using a file transfer tool 42.

An application 41 on the computer 40 removes the proprietary encoding, that has been added to the file 23 during encoding and offers the user a choice of methods for transferring the file 23 into their phone 50 by the file transfer tool 42. The choice is based on what transfer mechanism their phone 50 supports, but may include, infrared, Bluetooth, wireless LAN or cable.

The file transfer is a one-way-process so that the user cannot get the file 23 back from the phone 50. The phone 50 is passively copy protected by the phone specific format, in other words, the distribution value of the downloaded file 23 is limited by the specific format of the file that renders it non compatible with many other types of mobile phones.

In the above described embodiment each output file stored on the server is given a file name that indicates the associated profile used to encode the file. In an alternative embodiment each output file is assigned the same name, e.g sample video 0.3gp and the location of each output file on the server indicates which profile was used to create the file.

Advantageously, this makes it difficult for any observer to ascertain a link between any given output file and the profile used to create it. This limits the potential for obtaining an output file and sharing it over a file sharing network. There would be no easy way of an individual knowing whether a file available for downloading from such a network would be compatible with his or her device as the network would likely contain many files all with same name but all created with different profiles.

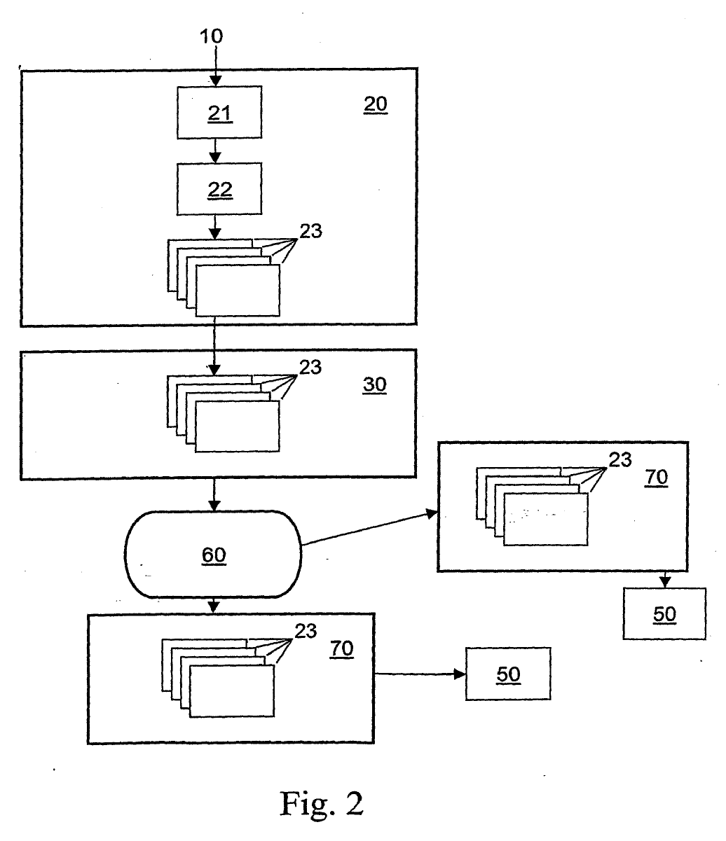

Referring now to FIG. 2 of the drawings a further embodiment of the invention is described. Like features in FIGS. 1 and 2 have the same reference numeral.

In this embodiment, a video file from a video clip source 10 is again input to video file processor 20. As described above, the video file processor 20 comprises encoding stage 21 which receives the video file as input and generates as output the multiple output files 23, each of which is formatted differently, such that different ones of the files 23 are compatible with different types of mobile phone.

The multiple output files 23 may again be encoded by additional encoding stage 22 in a proprietary file format to prevent unauthorised viewing on a PC type device rather than a mobile phone.

The multiple output files 23 are loaded onto the server 30 and from there are distributed over data network 60, for example the Internet or alternatively a private data network to at least one media server 70. Alternatively, the output files may be transmitted to the media servers 70 by means of physical disks.

The media servers 70 are typically located in publicly accessible sites, for example, a kiosk or shop run by a mobile phone dealership in a shopping centre.

Customers are able to take their mobile phone 50 to the location of a media sever 70 and pay the server's operator to download one of the plurality of video files 23 from the server 70 to their mobile phone 50. The mobile phone 50 is connected to the server 70 and the model of the mobile phone 50 is identified to the server 70. The server 70 in turn identifies which of the plurality of files 23 are especially adapted for playing on the model of mobile phone 50. Again, the server may achieve this by consulting a database of mobile phone model properties to identify the properties of the mobile phone 50 in order to match the phone 50 with appropriate files.

Again, a plurality of the files 23 may be suitable for display on the phone 50, each suitable file having a different video bandwidth speed. In this instance, the customer can select which file to download to the phone 50.

When a file transfer from a server 70 to a mobile phone 50 is complete, the file is available for the customer to play on the phone 50.

Preferably, the connection between a mobile device 50 and a server 70 is a wireless connection, for example a Bluetooth connection or a wireless LAN connection such as a WiFi connection.

It will be appreciated that distributing video files to mobile phones in this manner is particularly beneficial to mobile phone users who do not have access to computers and hence cannot make use of the embodiment described with respect to FIG. 1.

Although the preferred embodiments have been described with respect to video files and mobile phones, it will be appreciated that the invention is also applicable to different media files for example, audio files such as ringtones, image files or games applications. Furthermore, the invention is applicable to other types of portable or hand holdable electronic devices other than mobile phones, for example PDA's, portable games devices and MP3 players.

1. A method of making media files available for delivery to portable electronic devices, the method comprising: receiving media content as data input at an encoder; encoding the media content at the encoder to generate a plurality of output files each having the media content, each of the plurality of output files being specially adapted by the encoder for use with a different portable electronic device; and
storing the plurality of output files on a server for transmission there from over a communications link.

2. A method according to claim 1, the method further comprising:
transmitting at least one of the plurality of output files from the server over the communications link to enable reception of the at least one of the plurality of output files at a portable electronic device.

3. A method according to claim 1, the method further comprising: transmitting at least one of the plurality of output files from the server over a communications link to an electronic store to enable the at least one of the plurality of output files to be transferred from the electronic store to a portable electronic device.

4. A method according to claim 3, the method further comprising:
receiving data transmitted over the network from the electronic store, the data identifying a specific portable electronic device and determining that the at least one of the plurality of output files is specially adapted for use on the identified specific portable electronic device prior to transmitting the at least one of the plurality of output files to the electronic store.

5. A method according to claim 3 wherein the electronic store is a computing device connected to the network.

6. A method according to claim 5 wherein the computing device is a PC.

7. A method according to claim 3 wherein the electronic store is a second server connected to the network.

8. A method according to claim 7 wherein each of the plurality of files is transmitted from the first server to the second server, to enable the at least one of the plurality of output files to be transferred from the second server to a portable electronic device.

9. A method according to claim 1 wherein the plurality of output files are transferred to the server by means of physical storage media, to enable at least one of the plurality of output files to be transmitted from the server to a portable electronic device over the communication link.

10. A method according to claim 1 wherein the plurality of output files differ from each other in respect of at least one of compression format, bandwidth and general file format.

11. A method according to claim 10 wherein the plurality of output files differ from each other in respect of at least one of video compression format, audio compression format, video bandwidth, audio bandwidth and general file format.

12. A method according to claim 1, wherein the plurality of output files are encoded by the encoder in a way that inhibits unauthorised use of the plurality of output files.

13. A method according to claim 1 wherein the plurality of output files are video files, audio files, or image files.

14. A method according to claim 1 wherein the different portable electronic devices are different types of mobile phones.

15. A method according to claim 1 wherein the plurality of output files are generated by the encoder in parallel.

16. A method according to claim 1, the method further comprising generating a set of encoding profiles comprising a plurality of different encoding profiles each having a different combination of encoding parameters and wherein each output file is generated in dependence upon a different one of the encoding profiles.

17. A method according to claim 16, wherein each output file is stored at a location on the first server in dependence upon the profile used to generate the file.

18. A method of delivering a media file to a portable electronic device, the method comprising: downloading from a server to an electronic store over a communications network link a media file made available for delivery to portable electronic devices in accordance with claim 1; transferring the media file from the electronic store to a portable electronic device.

19. A method according to claim 18, wherein the portable electronic device is a mobile phone.

20. A method according to claim 18, wherein the media file is a video file, an audio file or a picture file.

21. A method according to 18 wherein the file is transferred from the electronic store to the portable electronic device via a cable, a local area network, an infra-red connection or a blue tooth connection.

22. A method according to claim 1 wherein the different portable electronic devices are different models selected from a specific class of portable electronic device.

23. Apparatus for making media files available for delivery to portable electronic devices, the apparatus comprising: an encoder for receiving media content as data input and encoding the media content to generate a plurality of output files each having the media content, and wherein each of the plurality of output files is formatted differently by the encoder so that the media content is available for use with a variety of different models of portable electronic devices; and a server for storing the plurality of output files for downloading there from over a communications link.

24. A system for delivering media content to mobile phones, in which system, media content is converted into a plurality of files of different formats so that the media content can be presented by a plurality of different mobile phone models, each format specially adapted for a different respective one of said mobile phone models and wherein said plurality of different files are stored together on a store and at least one file is transferred from the store to a mobile phone without using a mobile phone network connection.
